(19) United States
(12) Patent Application Publication
(10) Pub. No.: US 2025/0105436 A1
(43) Pub. Date: Mar. 27, 2025

(54) SECONDARY BATTERY

(71) Applicant: Prime Planet Energy & Solutions, Inc., Tokyo (JP)

(72) Inventors: Naoya TADA, Himeji-shi (JP); Hiroaki IMANISHI, Kobe-shi (JP)

(21) Appl. No.: 18/806,697

(22) Filed: Aug. 16, 2024

(30) Foreign Application Priority Data
Sep. 27, 2023 (JP) 2023-165252

(51) Int. Cl. H01M 50/342; H01M 50/103; H01M 50/186

(52) U.S. Cl. CPC H01M 50/3425; H01M 50/103; H01M 50/186

(57) ABSTRACT

A secondary battery includes: an electrode assembly; and a case, wherein the case includes a case main body provided with a first opening at one end portion of the case main body and a second opening at the other end portion of the case main body, a first sealing plate that seals the first opening, and a second sealing plate that seals the second opening, the case main body is provided with a joining portion extending from the first opening to the second opening, the joining portion having a shape of line, the joining portion has at least one bent portion at a position separated from the first opening and the second opening, and when pressure in the case becomes equal to or more than a predetermined value, the joining portion is fractured to discharge gas in the case to outside of the case.

### CROSS REFERENCE TO RELATED APPLICATIONS

This nonprovisional application is based on Japanese Patent Application No. 2023-165252 filed on Sep. 27, 2023 with the Japan Patent Office, the entire contents of which are hereby incorporated by reference.

### BACKGROUND OF THE INVENTION

### Field of the Invention

The present technology relates to a secondary battery.

### Description of the Background Art

Conventionally, a groove portion or a thin portion is formed in a wall surface of a case of a secondary battery so as to form a safety valve.

### SUMMARY OF THE INVENTION

In response to an increase in capacity of a battery, a secondary battery has become large in size. From the viewpoint of reliability in such a secondary battery having a large size, there is room for further improvement in the conventional secondary battery. An object of the present technology is to provide a secondary battery having high capacity and high reliability.

The present technology provides the following secondary battery.
[1] A secondary battery comprising: an electrode assembly including a first electrode and a second electrode having a polarity different from a polarity of the first electrode; and a case that accommodates the electrode assembly, wherein the case includes a case main body provided with a first opening at one end portion of the case main body in a first direction and a second opening at the other end portion of the case main body in the first direction, a first sealing plate that seals the first opening, and a second sealing plate that seals the second opening, the case main body is provided with a joining portion extending from the first opening to the second opening, the joining portion having a shape of line, the joining portion has at least one bent portion at a position separated from the first opening and the second opening, and when pressure in the case becomes equal to or more than a predetermined value, the joining portion is fractured to discharge gas in the case to outside of the case.
[2] The secondary battery according to [1], wherein the case main body includes a pair of first wall portions facing each other in a second direction orthogonal to the first direction, and the bent portion is provided in at least one of the first wall portions.
[3] The secondary battery according to [2], wherein the joining portion includes a first region and a second region located opposite to the first region with respect to the bent portion, each of the first region and the second region extends in the first direction, the at least one of the first wall portions has a first center line extending in the first direction through a center of the first wall portion in a third direction orthogonal to the first direction and the second direction, and the first region is located close to the first center line of the first wall portion with respect to the second region.
[4] The secondary battery according to [3], wherein the joining portion includes a plurality of the second regions and the first region formed between the plurality of the second regions in the first direction.
[5] The secondary battery according to [3], wherein the joining portion includes a plurality of the first regions and the second region formed between the plurality of the first regions in the first direction.
[6] The secondary battery according to [2], wherein the at least one of the first wall portions has a second center line extending in a third direction orthogonal to the first direction and the second direction through a center of the first wall portion in the first direction, and the joining portion is formed substantially symmetrically with respect to the second center line.
[7] The secondary battery according to [2], wherein the case main body includes a pair of second wall portions orthogonal to each other in a third direction orthogonal to the first direction and the second direction, and an area of each of the first wall portions is smaller than an area of each of the second wall portions.
[8] The secondary battery according to any one of [1] to [7], wherein the case main body is constituted of a plate-shaped member including a first end portion and a second end portion, and the joining portion is formed by welding the first end portion and the second end portion.
[9] The secondary battery according to any one of [1] to [8], wherein the case has a substantially rectangular parallelepiped shape.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing a configuration of a secondary battery according to a first embodiment.

FIG. 2 is a diagram showing a state in which the secondary battery shown in FIG. 1 is viewed in a direction of arrow II.

FIG. 3 is a diagram showing a state in which the secondary battery shown in FIG. 1 is viewed in a direction of arrow III.

FIG. 4 is a diagram showing a state in which the secondary battery shown in FIG. 1 is viewed in a direction of arrow IV.

FIG. 5 is a diagram showing a state in which the secondary battery shown in FIG. 1 is viewed in a direction of arrow V.

FIG. 6 is a front cross sectional view of the secondary battery shown in FIG. 1.

FIG. 7 is a front view showing a negative electrode raw plate before a negative electrode plate is formed.

FIG. 8 is a cross sectional view of the negative electrode raw plate shown in FIG. 7 along VIII-VIII.

FIG. 9 is a front view showing the negative electrode plate formed from the negative electrode raw plate.

FIG. 10 is a front view showing a positive electrode raw plate before a positive electrode plate is formed.

FIG. 11 is a cross sectional view of the positive electrode raw plate shown in FIG. 10 along XI-XI.

FIG. 12 is a front view showing the positive electrode plate formed from the positive electrode raw plate.

FIG. 13 is a first diagram showing a modification of each of bent portions of a joining portion.

FIG. 14 is a second diagram showing a modification of each of the bent portions of the joining portion.

FIG. 15 is a third diagram showing a modification of each of the bent portions of the joining portion.

FIG. 16 is a fourth diagram showing a modification of each of the bent portions of the joining portion.

FIG. 17 is a fifth diagram showing a modification of each of the bent portions of the joining portion.

FIG. 18 is a sixth diagram showing a modification of each of the bent portions of the joining portion.

FIG. 19 is a seventh diagram showing a modification of each of the bent portions of the joining portion.

FIG. 20 is a first diagram showing a modification of a shape of the joining portion.

FIG. 21 is a second diagram showing a modification of the shape of the joining portion.

FIG. 22 is a third diagram showing a modification of the shape of the joining portion.

FIG. 23 is a diagram showing a state of the secondary battery shown in FIG. 22 when viewed in a direction of arrow XXIII-XXIII.

FIG. 24 is a schematic view showing an exemplary arrangement of a gas-discharge valve (fragile portions).

FIG. 25 is a first diagram showing an exemplary cross section of the joining portion.

FIG. 26 is a second diagram showing an exemplary cross section of the joining portion.

FIG. 27 is a third diagram showing an exemplary cross section of the joining portion.

FIG. 28 is a fourth diagram showing an exemplary cross section of the joining portion.

FIG. 29 is a fifth diagram showing an exemplary cross section of the joining portion.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “secondary battery” is not limited to a lithium ion battery, and may include other secondary batteries such as a nickel-metal hydride battery and a sodium-ion battery. In the present specification, the term “electrode” may collectively represent a positive electrode and a negative electrode.

Further, the “secondary battery” in the present technology is not limited to a prismatic battery and may be a cylindrical battery.

It should be noted that in each of the figures, the X direction is defined to represent a direction along a winding axis of an electrode assembly included in the secondary battery, the Y direction is defined to represent a short-side direction of the electrode assembly when viewed in the X direction, and the Z direction is defined to represent a long-side direction of the electrode assembly when viewed in the X direction. Further, in order to facilitate understanding of the invention, the size of each configuration in the figures may be illustrated to be changed from its actual size.

In the specification of the present application, the first direction (X direction) may be referred to as a “width direction” of the secondary battery or the case main body, the second direction (Z direction) may be referred to as a “height direction” of the secondary battery or the case main body, and the third direction (Y direction) may be referred to as a “thickness direction” of the secondary battery or the case main body.

### (Overall Configuration of Battery)

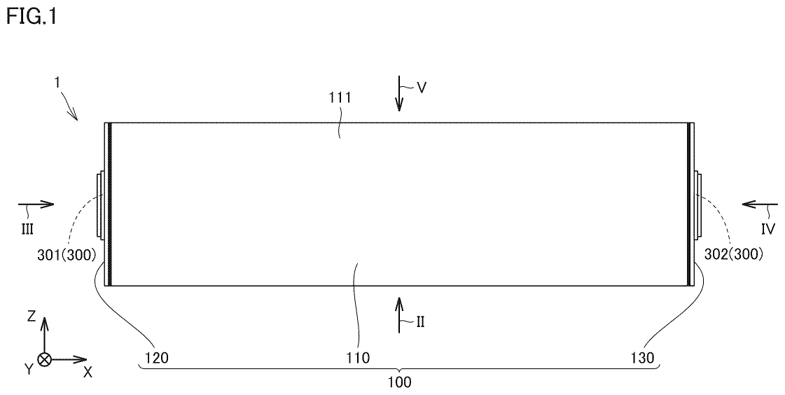

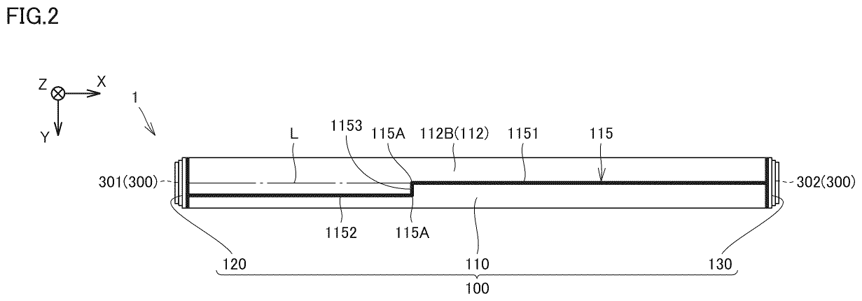

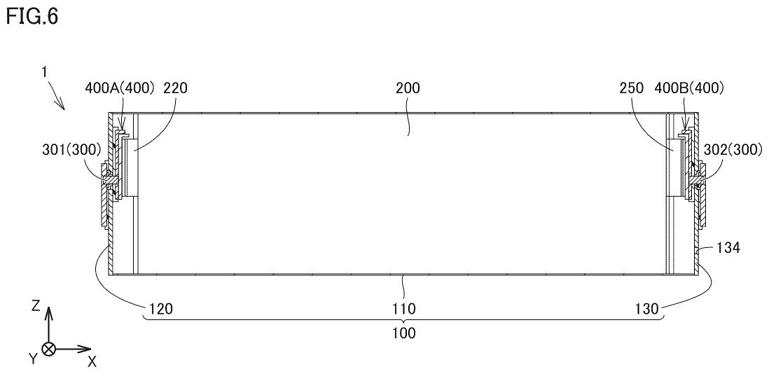

FIG. 1 is a front view of a secondary battery 1 according to the present embodiment. FIGS. 2 to 5 are diagrams showing states of secondary battery 1 shown in FIG. 1 when viewed in directions of arrows II, III, IV, and V respectively. FIG. 6 is a front cross sectional view of secondary battery 1 shown in FIG. 1.

Secondary battery 1 can be mounted on a battery electric vehicle (BEV), a plug-in hybrid electric vehicle (PHEV), a hybrid electric vehicle (HEV), or the like. It should be noted that the purpose of use of secondary battery 1 is not limited to the use on a vehicle.

As shown in FIGS. 1 to 6, secondary battery 1 includes a case 100, an electrode assembly 200, electrode terminals 300, and current collectors 400. Case 100 includes a case main body 110, a sealing plate 120, and a sealing plate 130. Case 100 has a substantially rectangular parallelepiped shape.

When forming a battery assembly including secondary battery 1, a plurality of secondary batteries 1 are stacked in the thickness direction of each of the plurality of secondary batteries 1. Secondary batteries 1 stacked may be restrained in the stacking direction (Y direction) by a restraint member to form a battery module, or the battery assembly may be directly supported by a side surface of a case of a battery pack without using the restraint member.

Case main body 110 is constituted of a member having a tubular shape, preferably, a prismatic tubular shape. Thus, secondary battery 1 having a prismatic shape is obtained. Case main body 110 is composed of a metal. Specifically, case main body 110 is composed of aluminum, an aluminum alloy, iron, an iron alloy, or the like.

As shown in FIGS. 1 and 2, sealing plate 120 and sealing plate 130 are provided at respective end portions of the case main body. Case main body 110 can be formed to have a prismatic tubular shape in, for example, the following manner: end sides of a plate-shaped member having been bent are brought into abutment with each other (joining portion 115 illustrated in FIG. 2) and are joined together (for example, laser welding). Each of the corners of the “prismatic tubular shape” may have a shape with a curvature.

In the present embodiment, case main body 110 is formed to be longer in the width direction (X direction) of secondary battery 1 than in each of the thickness direction (Y direction) and the height direction (Z direction) of secondary battery 1. The size (width) of case main body 110 in the X direction is preferably about 15 cm or more and is more preferably about 30 cm or more. In this way, secondary battery 1 can be formed to have a relatively large size (high capacity). The size (height) of case main body 110 in the Z direction is preferably about 20 cm or less, more preferably about 15 cm or less, and further preferably about 10 cm or less. Thus, (low-height) secondary battery 1 having a relatively low height can be formed, thus resulting in improved ease of mounting on a vehicle, for example.

Case main body 110 includes a pair of side surface portions 111 (second wall portions) and a pair of side surface portions 112 (first wall portions). The pair of side surface portions 111 constitute parts of the side surfaces of case 100. The pair of side surface portions 112 constitute the bottom surface portion and upper surface portion of case 100. The pair of side surface portions 111 and the pair of side surface portions 112 are provided to intersect each other. The pair of side surface portions 111 and the pair of side surface portions 112 are adjacent to each other. Each of the pair of side surface portions 111 desirably has an area larger than that of each of the pair of side surface portions 112.

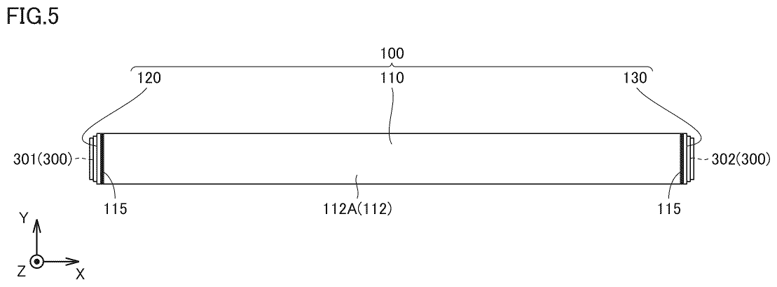

As shown in FIGS. 2 and 5, side surface portion 112 includes a pair of side surface portions 112A, 112B. Each of side surface portions 112A, 112B has a substantially rectangular shape in which the X direction corresponds to its long-side direction and the Y direction corresponds to its short-side direction.

As shown in FIG. 2, joining portion 115 is formed at one side surface portion 112B of the pair of side surface portions 112. Joining portion 115 can be formed in, for example, the following manner: the base material is melted by application of a high-energy ray such as laser light and is then solidified.

In side surface portion 112B, joining portion 115 is formed to have a shape of line extending across a whole of secondary battery 1, i.e., from its end portion on one side to its end portion on the other side in the width direction (X direction). At joining portion 115, the end sides (end portions) of the plate-shaped member of case main body 110 are joined to each other.

Joining portion 115 includes a first region 1151, a second region 1152, and a third region 1153. Each of first region 1151 and second region 1152 extends in the X direction. Third region 1153 connects first region 1151 and second region 1152. Third region 1153 extends in the Y direction. Bent portions 115A (flection portions) are formed between first region 1151 and third region 1153 and between second region 1152 and third region 1153.

First region 1151 of joining portion 115 is located on a center line L (first center line) of side surface portion 112B. Center line L extends in the X direction through the center of side surface portion 112B in the Y direction. Second region 1152 extends through a position deviated from center line L in the Y direction.

In secondary battery 1 according to the present embodiment, joining portion 115 has a function of a gas-discharge valve (safety valve) that is fractured when pressure in case 100 becomes equal to or more than a predetermined value and that discharges gas in case 100 to outside of case 100.

Since first region 1151 of joining portion 115 is located on center line L, first region 1151 is more greatly displaced when the pressure of case 100 is increased, with the result that stress is likely to be increased therein. Therefore, when joining portion 115 is caused to function as a gas-discharge valve (safety valve), first region 1151 can be ruptured preferentially.

Thus, since joining portion 115 is provided with the function of a gas-discharge valve and is provided with bent portions 115A, the position of rupture of joining portion 115 (gas-discharge valve) can be specified, thereby suppressing damage of the battery pack at the time of discharging of gas. Therefore, secondary battery 1 having high reliability can be manufactured while suppressing an increase in manufacturing cost.

It should be noted that the expression “first region 1151 is ruptured preferentially” is not limited to meaning “only first region 1151 is ruptured”, and includes, for example, the following case: “first region 1151 is ruptured first and then second region 1152 is ruptured”.

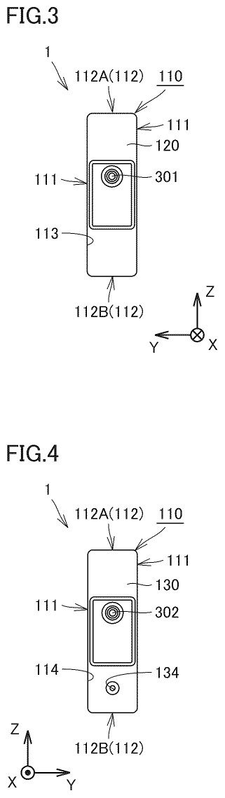

As shown in FIG. 3, an opening 113 (first opening) is provided at an end portion of case main body 110 on a first side in the first direction (X direction). Opening 113 is sealed by sealing plate 120. Joining portion 115 is formed at opening 113 so as to seal opening 113. Each of opening 113 and sealing plate 120 has a substantially rectangular shape in which the Y direction corresponds to its short-side direction and the Z direction corresponds to its long-side direction. It should be noted that the rectangular shape includes a rectangular shape or a generally rectangular shape such as a rectangular shape having corners each with a curvature.

Sealing plate 120 (first sealing plate) is provided with a negative electrode terminal 301. The position of negative electrode terminal 301 can be appropriately changed.

As shown in FIG. 4, an opening 114 (second opening) is provided at an end portion of case main body 110 on a second side opposite to the first side in the first direction (X direction). That is, opening 114 is located at an end portion opposite to opening 113, and openings 113, 114 face each other. Opening 114 is sealed by sealing plate 130. Joining portion 115 is formed at opening 114 so as to seal opening 114. Each of opening 114 and sealing plate 130 has a substantially rectangular shape in which the Y direction corresponds to its short-side direction and the Z direction corresponds to its long-side direction.

Sealing plate 130 (second sealing plate) is provided with a positive electrode terminal 302 and an injection hole 134. The positions of positive electrode terminal 302 and injection hole 134 can be appropriately changed.

Each of sealing plate 120 and sealing plate 130 is composed of a metal. Specifically, each of sealing plate 120 and sealing plate 130 is composed of aluminum, an aluminum alloy, iron, an iron alloy, or the like.

Negative electrode terminal 301 (first electrode terminal) is electrically connected to a negative electrode of electrode assembly 200. Negative electrode terminal 301 is attached to sealing plate 120, i.e., case 100.

Positive electrode terminal 302 (second electrode terminal) is electrically connected to a positive electrode of electrode assembly 200. Positive electrode terminal 302 is attached to sealing plate 130, i.e., case 100.

Negative electrode terminal 301 is composed of a conductive material (more specifically, a metal), and can be composed of copper, a copper alloy, or the like, for example. A portion or layer composed of aluminum or an aluminum alloy may be provided at a portion of an outer surface of negative electrode terminal 301.

Positive electrode terminal 302 is composed of a conductive material (more specifically, a metal), and can be composed of aluminum, an aluminum alloy, or the like, for example.

Injection hole 134 is sealed by a sealing member (not shown). As the sealing member, for example, a blind rivet or another metal member can be used.

Electrode assembly 200 is an electrode assembly having a flat shape and having a below-described positive electrode plate and a below-described negative electrode plate. Specifically, electrode assembly 200 is a wound type electrode assembly in which a strip-shaped positive electrode plate and a strip-shaped negative electrode plate are both wound with a strip-shaped separator (not shown) being interposed therebetween. It should be noted that in the present specification, the “electrode assembly” is not limited to the wound type electrode assembly, and may be a stacked type electrode assembly in which a plurality of positive electrode plates and a plurality of negative electrode plates are alternately stacked. The strip-shaped separator can be constituted of, for example, a microporous membrane composed of polyolefin. The electrode assembly may include a plurality of positive electrode plates and a plurality of negative electrode plates, respective positive electrode tabs provided in the positive electrode plates may be stacked to form a positive electrode tab group, and respective negative electrode tabs provided in the negative electrode plates may be stacked to form a negative electrode tab group. It should be noted that electrode assembly 200 may include a plurality of wound type electrode assemblies or may include a plurality of stacked type electrode assemblies.

As shown in FIG. 6, case 100 accommodates electrode assembly 200. Electrode assembly 200 is accommodated in case 100 such that the winding axis thereof is parallel to the X direction.

Specifically, one or a plurality of the wound type electrode assemblies and an electrolyte solution (electrolyte) (not shown) are accommodated inside a below-described insulating sheet disposed in case 100. As the electrolyte solution (non-aqueous electrolyte solution), it is possible to use, for example, a solution obtained by dissolving LiPF₆ at a concentration of 1.2 mol/L in a non-aqueous solvent obtained by mixing ethylene carbonate (EC), ethyl methyl carbonate (EMC), and diethyl carbonate (DEC) at a volume ratio (25° C.) of 30:30:40. It should be noted that instead of the electrolyte solution, a solid electrolyte may be used.

Electrode assembly 200 includes: a main body portion (portion in which a positive electrode plate and a negative electrode plate are stacked with a separator being interposed therebetween); a negative electrode tab group 220; and a positive electrode tab group 250.

The main body portion is constituted of a below-described negative electrode plate 210 and a below-described positive electrode plate 240. Negative electrode tab group 220 is located at an end portion of electrode assembly 200 on the first side with respect to the main body portion in the first direction (X direction). The first side in the present embodiment is the sealing plate 120 side. Positive electrode tab group 250 is located at an end portion of electrode assembly 200 on the second side with respect to the main body portion in the first direction (X direction). The second side in the present embodiment is the sealing plate 130 side.

Each of negative electrode tab group 220 and positive electrode tab group 250 is formed to protrude from a central portion of electrode assembly 200 toward sealing plate 120 or sealing plate 130.

Current collectors 400 include a negative electrode current collector 400A and a positive electrode current collector 400B. Each of negative electrode current collector 400A and positive electrode current collector 400B is constituted of a plate-shaped member. Electrode assembly 200 is electrically connected to negative electrode terminal 301 and positive electrode terminal 302 through current collectors 400.

Negative electrode current collector 400A is disposed on sealing plate 120 with an insulating member composed of a resin being interposed therebetween. Negative electrode current collector 400A is electrically connected to negative electrode tab group 220 and negative electrode terminal 301. Negative electrode current collector 400A is composed of a conductive material (more specifically, a metal), and can be composed of copper, a copper alloy, or the like, for example. It should be noted that details of negative electrode current collector 400A will be described later.

Positive electrode current collector 400B is disposed on sealing plate 130 with an insulating member composed of a resin being interposed therebetween. Positive electrode current collector 400B is electrically connected to positive electrode tab group 250 and positive electrode terminal 302. Positive electrode current collector 400B is composed of a conductive material (more specifically, a metal), and can be composed of aluminum, an aluminum alloy, or the like, for example. It should be noted that positive electrode tab group 250 may be electrically connected to sealing plate 130 directly or via positive electrode current collector 400B. In this case, sealing plate 130 may serve as positive electrode terminal 302. Moreover, details of positive electrode current collector 400B will be described later.

### (Configuration of Electrode Assembly 200)

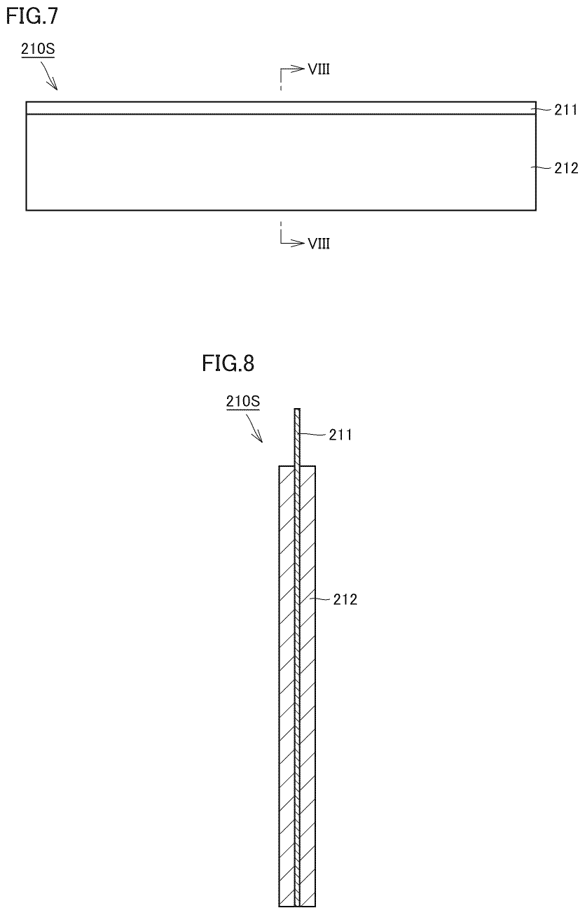

FIG. 7 is a front view showing a negative electrode raw plate 210S before negative electrode plate 210 is formed, FIG. 8 is a cross sectional view of negative electrode raw plate 210S shown in FIG. 7 along VIII-VIII, and FIG. 9 is a front view showing negative electrode plate 210 formed from negative electrode raw plate 210S.

Negative electrode plate 210 is manufactured by processing negative electrode raw plate 210S. As shown in FIGS. 7 and 8, negative electrode raw plate 210S includes a negative electrode core body 211 (first electrode core body) and a negative electrode active material layer 212. Negative electrode core body 211 is a copper foil or a copper alloy foil.

Negative electrode active material layer 212 is formed on negative electrode core body 211 except for each of end portions of both surfaces of negative electrode core body 211 on one side. Negative electrode active material layer 212 is formed by applying a negative electrode active material layer slurry using a die coater.

The negative electrode active material layer slurry is produced by kneading graphite serving as a negative electrode active material, styrene-butadiene rubber (SBR) and carboxymethyl cellulose (CMC) each serving as a binder, and water serving as a dispersion medium such that the mass ratio of the graphite, the SBR, and the CMC is about 98:1:1.

Negative electrode core body 211 having the negative electrode active material layer slurry applied thereon is dried to remove the water included in the negative electrode active material layer slurry, thereby forming negative electrode active material layer 212. Further, by compressing negative electrode active material layer 212, negative electrode raw plate 210S including negative electrode core body 211 and negative electrode active material layer 212 is formed. Negative electrode raw plate 210S is cut into a predetermined shape, thereby forming negative electrode plate 210. Negative electrode raw plate 210S can be cut by laser processing with application of an energy ray, die processing, cutter processing, or the like.

As shown in FIG. 9, a plurality of negative electrode tabs 230 (first electrode tabs) each constituted of negative electrode core body 211 are provided at one end portion, in the width direction, of negative electrode plate 210 formed from negative electrode raw plate 210S. When negative electrode plate 210 is wound, the plurality of negative electrode tabs 230 are stacked to form negative electrode tab group 220. Thus, negative electrode tab group 220 is connected to negative electrode plate 210. The position of each of the plurality of negative electrode tabs 230 and the length thereof in the protruding direction are appropriately adjusted in consideration of the state in which negative electrode tab group 220 is connected to negative electrode current collector 400A. It should be noted that the shape of negative electrode tab 230 is not limited to the one illustrated in FIG. 8.

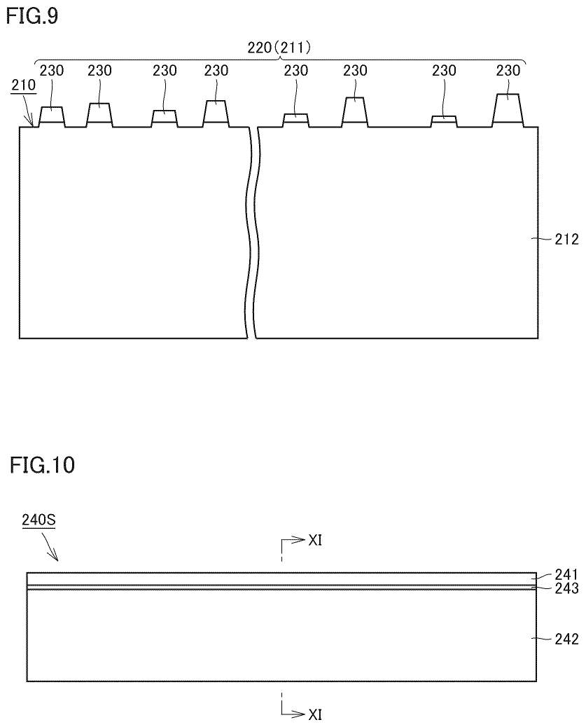

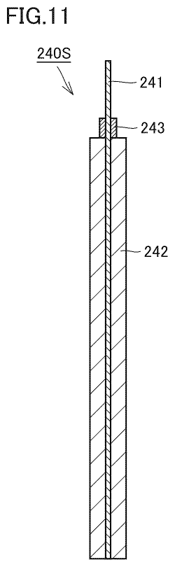

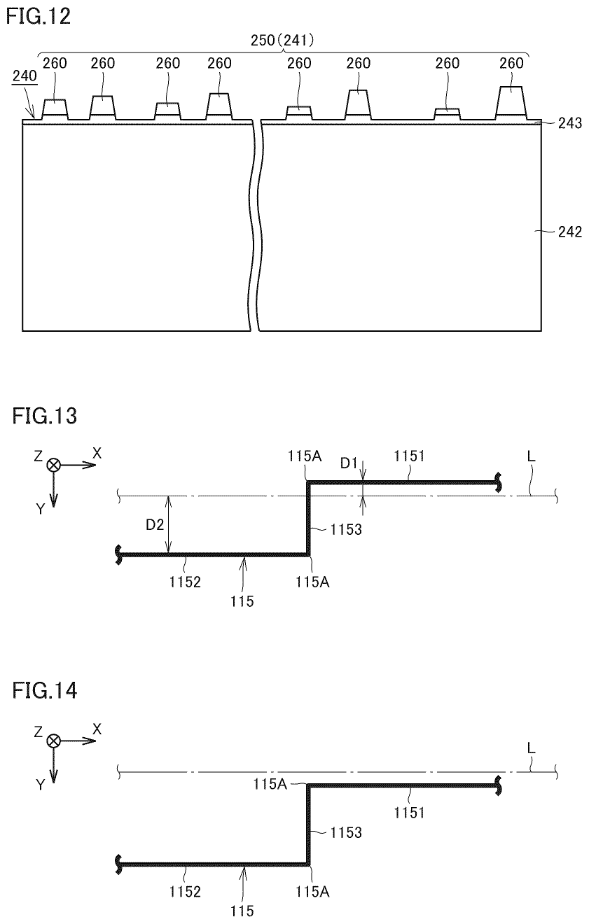

FIG. 10 is a front view showing a positive electrode raw plate 240S before positive electrode plate 240 is formed, FIG. 11 is a cross sectional view of positive electrode raw plate 240S shown in FIG. 10 along XI-XI, and FIG. 12 is a front view showing positive electrode plate 240 formed from positive electrode raw plate 240S.

Positive electrode plate 240 serving as the second electrode has a polarity different from a polarity of negative electrode plate 210 serving as the first electrode. Positive electrode plate 240 is manufactured by processing positive electrode raw plate 240S. As shown in FIGS. 10 and 11, positive electrode raw plate 240S includes a positive electrode core body 241 (second electrode core body), a positive electrode active material layer 242, and a positive electrode protective layer 243. Positive electrode core body 241 is an aluminum foil or an aluminum alloy foil.

Positive electrode active material layer 242 is formed on positive electrode core body 241 except for each of end portions of both surfaces of positive electrode core body 241 on one side. Positive electrode active material layer 242 is formed on positive electrode core body 241 by applying a positive electrode active material layer slurry using a die coater.

The positive electrode active material layer slurry is produced by kneading a lithium-nickel-cobalt-manganese composite oxide serving as a positive electrode active material, polyvinylidene difluoride (PVdF) serving as a binder, a carbon material serving as a conductive material, and N-methyl-2-pyrrolidone (NMP) serving as a dispersion medium such that the mass ratio of the lithium-nickel-cobalt-manganese composite oxide, the PVdF, and the carbon material is about 97.5:1:1.5.

Positive electrode protective layer 243 is formed in contact with positive electrode core body 241 at an end portion of positive electrode active material layer 242 on the one side in the width direction. Positive electrode protective layer 243 is formed on positive electrode core body 241 by applying a positive electrode protective layer slurry using a die coater. Positive electrode protective layer 243 has an electrical resistance larger than that of positive electrode active material layer 242.

The positive electrode protective layer slurry is produced by kneading alumina powder, a carbon material serving as a conductive material, PVdF serving as a binder, and NMP serving as a dispersion medium such that the mass ratio of the alumina powder, the carbon material, and the PVdF is about 83:3:14.

Positive electrode core body 241 having the positive electrode active material layer slurry and the positive electrode protective layer slurry applied thereon is dried to remove the NMP included in the positive electrode active material layer slurry and the positive electrode protective layer slurry, thereby forming positive electrode active material layer 242 and positive electrode protective layer 243. Further, by compressing positive electrode active material layer 242, positive electrode raw plate 240S including positive electrode core body 241, positive electrode active material layer 242, and positive electrode protective layer 243 is formed. Positive electrode raw plate 240S is cut into a predetermined shape, thereby forming positive electrode plate 240. Positive electrode raw plate 240S can be cut by laser processing with application of an energy ray, die processing, cutter processing, or the like.

As shown in FIG. 12, a plurality of positive electrode tabs 260 (second electrode tabs) each constituted of positive electrode core body 241 are provided at one end portion, in the width direction, of positive electrode plate 240 formed from positive electrode raw plate 240S. When positive electrode plate 240 is wound, the plurality of positive electrode tabs 260 are stacked to form positive electrode tab group 250. Thus, positive electrode tab group 250 is connected to positive electrode plate 240. The position of each of the plurality of positive electrode tabs 260 and the length thereof in the protruding direction are appropriately adjusted in consideration of the state in which positive electrode tab group 250 is connected to positive electrode current collector 400B. It should be noted that the shape of positive electrode tab 260 is not limited to the one illustrated in FIG. 12.

Positive electrode protective layer 243 is provided at the root of each of the plurality of positive electrode tabs 260. Positive electrode protective layer 243 may not necessarily be provided at the root of positive electrode tab 260.

In a typical example, the thickness of (one) negative electrode tab 230 is smaller than the thickness of (one) positive electrode tab 260. In this case, the thickness of negative electrode tab group 220 is smaller than the thickness of positive electrode tab group 250.

### (Shape of Joining Portion 115 Including Bent Portions 115A)

FIGS. 13 to 19 are diagrams showing modifications of bent portions 115A of joining portion 115.

As shown in FIGS. 13 to 19, first region 1151 of joining portion 115 does not necessarily need to be located on center line L, and may be located close to center line L with respect to second region 1152.

For example, in the example of FIG. 13, first region 1151 is located on one side with respect to center line L in the Y direction, and second region 1152 is located on the other side with respect to center line L in the Y direction. When D1 is defined to represent a distance between center line L and first region 1151 and D2 is defined to represent a distance between center line L and second region 1152, the following relation is preferably satisfied:

D2/D1>1.2.

In this way, stress can be generated to be more concentrated in first region 1151, with the result that the location of preferential rupture can be specified more securely.

In the example of FIG. 14, first region 1151 and second region 1152 are located on the same side with respect to center line L in the Y direction, but first region 1151 is close to center line L with respect to second region 1152.

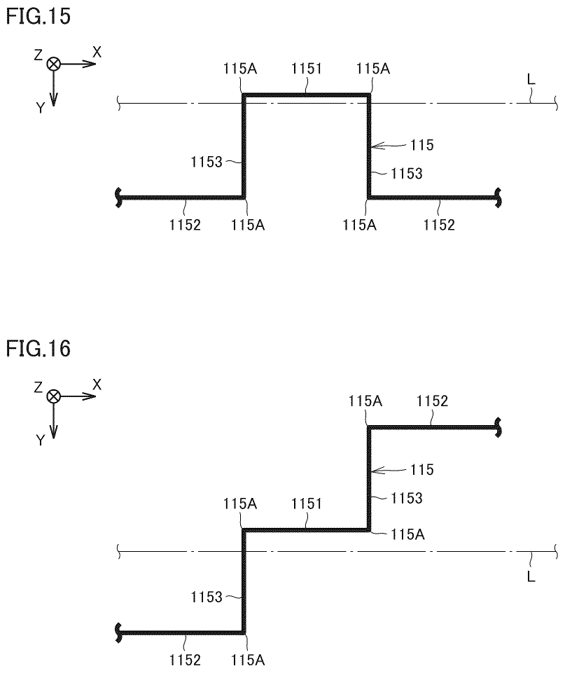

In each of the examples of FIGS. 15 and 16, bent portions 115A are formed at four locations. The number and positions of bent portions 115A are not particularly limited, and can be appropriately changed.

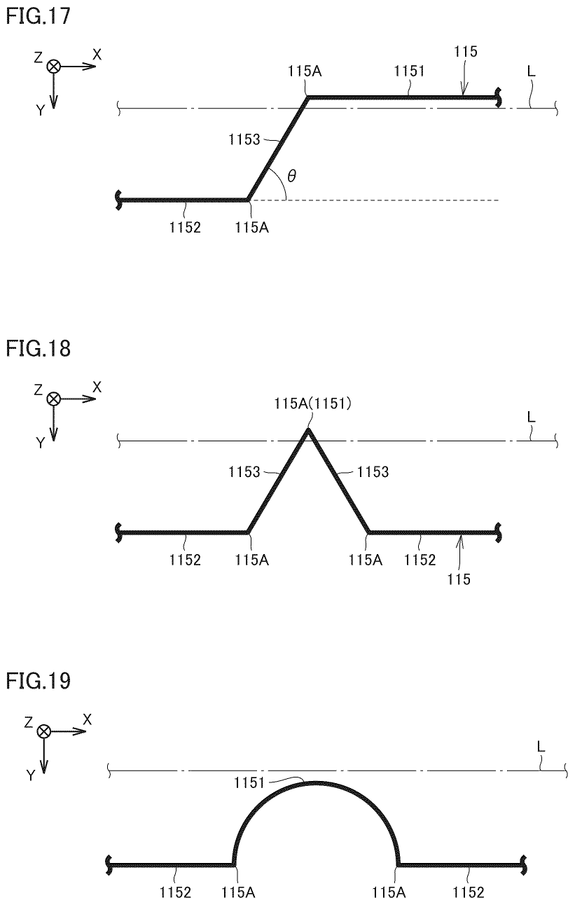

In the example of FIG. 17, an intersection angle between each of first region 1151 and second region 1152 and third region 1153 in bent portion 115A is not 90°, and they intersect each other obliquely (at an angle different from) 90°. An intersection angle (θ in FIG. 17) of third region 1153 with respect to the X direction (the extending direction of each of first region 1151 and second region 1152) is preferably 80° or less, and is more preferably 60° or less. In this way, rupture caused from first region 1151 can be more likely to reach second region 1152 through bent portions 115A.

In the example of FIG. 18, first region 1151 close to center line L is formed to have a shape of point, rather than the shape of line. In the example of FIG. 19, first region 1151 sandwiched between second regions 1152 is formed to have a substantially shape of arc.

In each of the examples of FIGS. 13 to 19, the shortest distance between first region 1151 and center line L is preferably about 5 mm or less, is more preferably about 3 mm or less, and is further preferably about 2 mm or less.

### (Arrangement of First Region 1151 and Second Region 1152)

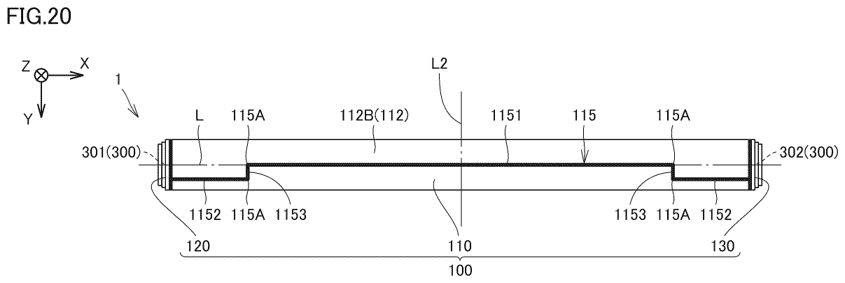

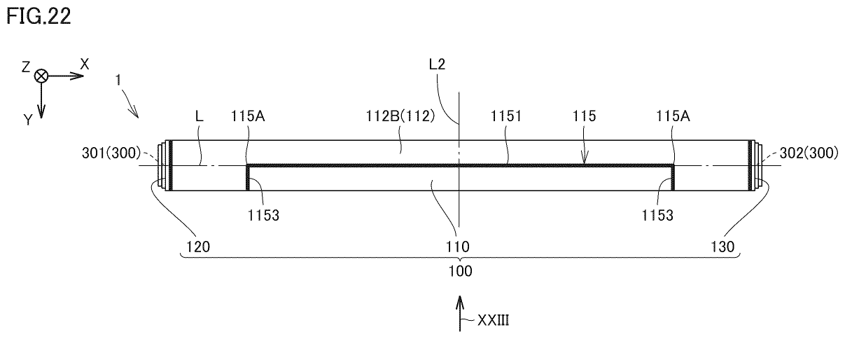

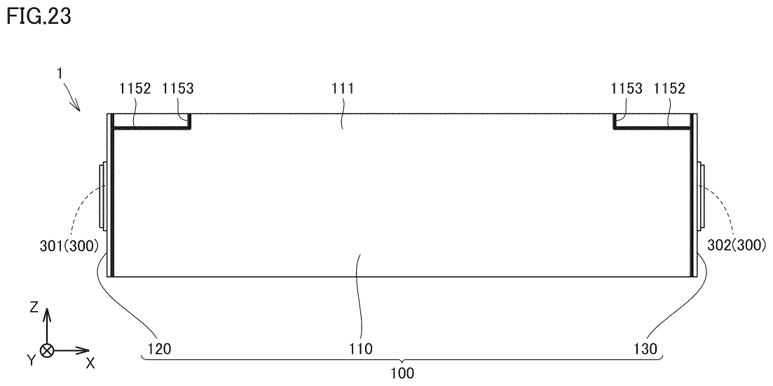

FIGS. 20 to 23 are diagrams showing modifications of the shape of joining portion 115. FIG. 23 shows a state of secondary battery 1 shown in FIG. 22 when viewed in a direction of arrow XXIII-XXIII.

In the example of FIG. 20, joining portion 115 includes a plurality of (two) second regions 1152 and a first region 1151 formed between two second regions 1152 in the X direction. Joining portion 115 is formed substantially symmetrically with respect to a center line L2 (second center line). Center line L2 extends in the Y direction through the center of side surface portion 112B in the X direction.

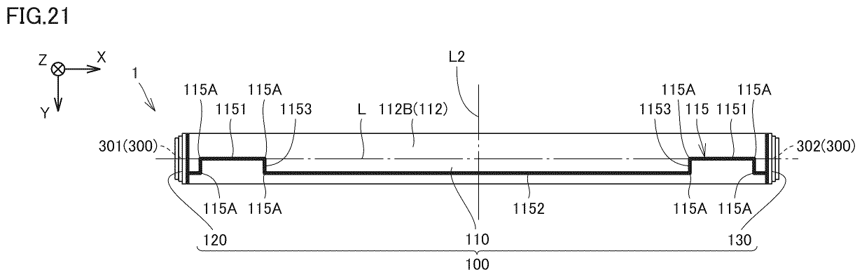

In the example of FIG. 21, joining portion 115 includes a plurality of (two) first regions 1151 and a second region 1152 formed between two first regions 1151 in the X direction. Joining portion 115 is formed substantially symmetrically with respect to center line L2.

In the example of FIGS. 22 and 23, joining portion 115 includes a plurality of (two) second regions 1152 and a first region 1151 formed between two second regions 1152 in the X direction. As shown in FIG. 22, first region 1151 is formed in side surface portion 112B. On side surface portion 112B, joining portion 115 is formed substantially symmetrically with respect to center line L2. As shown in FIG. 23, second regions 1152 are formed in side surface portion 111. Each of third regions 1153 is formed to extend from side surface portion 112B to reach side surface portion 111.

As described above, in each of the three examples shown in FIGS. 20 to 23, joining portion 115 (first region 1151) is formed substantially symmetrically with respect to center line L2 extending through the center in the X direction.

When a plurality of secondary batteries 1 are connected in series, the plurality of secondary batteries 1 are arranged in a state in which the orientations thereof are alternately changed such that negative electrode terminals 301 and positive electrode terminals 302 are alternately arranged side by side in the Y direction. On this occasion, since each of first regions 1151 is symmetrically disposed with respect to center line L2, first regions 1151 are arranged side by side in the Y direction even in the case where secondary batteries 1 are arranged such that the orientations thereof are alternately changed, with the result that positions (discharge positions in the X direction) from which gas is discharged when internal pressure of case 100 is increased substantially coincide with each other among the plurality of secondary batteries 1.

In each of the examples of FIGS. 20 to 23, the total length of first region 1151 in the X direction (a sum of the lengths of a plurality of first regions 1151 when there are the plurality of first regions 1151) is preferably about ⅕ or more, and more preferably about ⅓ or more of the length of case main body 110 in the X direction.

In each of the examples of FIGS. 20 to 23, first region 1151 is not formed in the vicinity of each of openings 113, 114 (region of about 5 mm or less in the X direction from each of openings 113, 114). Thus, first region 1151 is preferably separated from each of openings 113, 114 by a predetermined distance. Since first region 1151 is not provided in the vicinity of each of openings 113, 114, unintended rupture can be suppressed from being caused between case main body 110 and each of sealing plates 120, 130 when the internal pressure of case 100 is increased.

### (Arrangement of Fragile Portions)

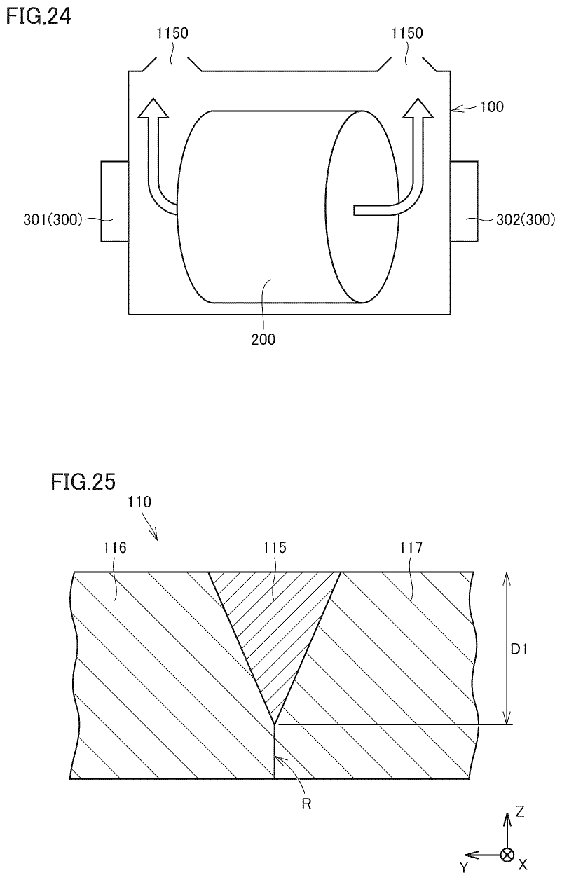

FIG. 24 is a schematic view showing an exemplary arrangement of fragile portions 1150 in joining portion 115. As shown in FIG. 24, when electrode assembly 200 is a wound type electrode assembly, gas generated inside electrode assembly 200 is discharged to outside of electrode assembly 200 from each of the both end portions of electrode assembly 200 in the X direction. Therefore, fragile portions 1150 (gas-discharge valve) are preferably provided to respectively face the both ends of electrode assembly 200 in the X direction (above negative electrode tab group 220 and positive electrode tab group 250).

For example, as shown in FIG. 21, when the arrangement in which first regions 1151 are respectively provided at the both end portions in the X direction, it is possible to realize the arrangement of fragile portions 1150 shown in the schematic diagram of FIG. 24.

### (Structure of Joining Portion 115)

FIGS. 25 to 29 are diagrams showing exemplary cross sections of joining portion 115. In each of the examples of FIGS. 25 to 29, first end portion 116 and second end portion 117 of the plate-shaped member constituting case main body 110 are joined by joining portion 115. In this way, case main body 110 having a prismatic tubular shape is formed.

In the example of FIG. 25, joining portion 115 is formed by bringing first end portion 116 and second end portion 117 into abutment with each other and welding them in region R. A welding depth D1 shown in FIG. 25 can be different between first region 1151 and second region 1152 (for example, D1 in first region 1151 can be smaller than that in second region 1152).

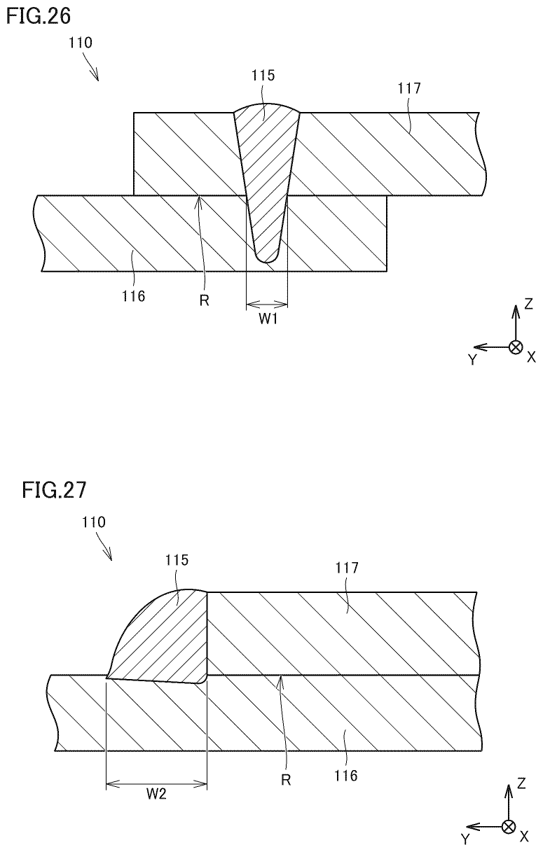

In the example of FIG. 26, first end portion 116 and second end portion 117 are overlapped with each other in region R and pierce welding is performed at region R, thereby forming joining portion 115. A welding width W1 (width at a boundary between first end portion 116 and second end portion 117) shown in FIG. 26 can be different between first region 1151 and second region 1152 (for example, W1 in first region 1151 is smaller than that in second region 1152).

In the example of FIG. 27, first end portion 116 and second end portion 117 are overlapped with each other in region R and fillet welding is performed at a location adjacent to region R, thereby forming joining portion 115. A welding width W2 shown in FIG. 27 can be different between first region 1151 and second region 1152 (for example, W2 in first region 1151 is smaller than that in second region 1152).

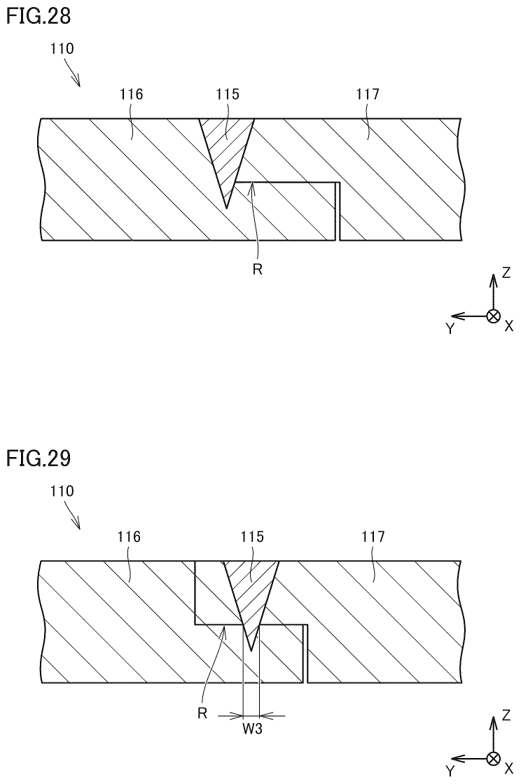

In each of the examples of FIGS. 28 and 29, first end portion 116 and second end portion 117 are provided with protruding/recessed shapes, the protruding/recessed shapes are engaged with each other to form region R, and welding is performed at region R or a region adjacent thereto, thereby forming joining portion 115. A welding width W3 (width at a boundary between first end portion 116 and second end portion 117) shown in FIG. 29 can be different between first region 1151 and second region 1152 (for example, W3 in first region 1151 is smaller than that in second region 1152).

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A secondary battery comprising:
an electrode assembly including a first electrode and a second electrode having a polarity different from a polarity of the first electrode; and
a case that accommodates the electrode assembly, wherein
the case includes a case main body provided with a first opening at one end portion of the case main body in a first direction and a second opening at the other end portion of the case main body in the first direction, a first sealing plate that seals the first opening, and a second sealing plate that seals the second opening,
the case main body is provided with a joining portion extending from the first opening to the second opening, the joining portion having a shape of line,
the joining portion has at least one bent portion at a position separated from the first opening and the second opening, and
when pressure in the case becomes equal to or more than a predetermined value, the joining portion is fractured to discharge gas in the case to outside of the case.

2. The secondary battery according to claim 1, wherein
the case main body includes a pair of first wall portions facing each other in a second direction orthogonal to the first direction, and
the bent portion is provided in at least one of the first wall portions.

3. The secondary battery according to claim 2, wherein
the joining portion includes a first region and a second region located opposite to the first region with respect to the bent portion,
each of the first region and the second region extends in the first direction,
the at least one of the first wall portions has a first center line extending in the first direction through a center of the first wall portion in a third direction orthogonal to the first direction and the second direction, and
the first region is located close to the first center line of the first wall portion with respect to the second region.

4. The secondary battery according to claim 3, wherein the joining portion includes a plurality of the second regions and the first region formed between the plurality of the second regions in the first direction.

5. The secondary battery according to claim 3, wherein the joining portion includes a plurality of the first regions and the second region formed between the plurality of the first regions in the first direction.

6. The secondary battery according to claim 2, wherein
the at least one of the first wall portions has a second center line extending in a third direction orthogonal to the first direction and the second direction through a center of the first wall portion in the first direction, and
the joining portion is formed substantially symmetrically with respect to the second center line.

7. The secondary battery according to claim 2, wherein
the case main body includes a pair of second wall portions orthogonal to each other in a third direction orthogonal to the first direction and the second direction, and
an area of each of the first wall portions is smaller than an area of each of the second wall portions.

8. The secondary battery according to claim 1, wherein
the case main body is constituted of a plate-shaped member including a first end portion and a second end portion, and
the joining portion is formed by welding the first end portion and the second end portion.

9. The secondary battery according to claim 1, wherein
the case main body includes a pair of first wall portions facing each other in a second direction orthogonal to the first direction,
the bent portion is provided in at least one of the first wall portions,
the case main body is constituted of a plate-shaped member including a first end portion and a second end portion, and
the joining portion is formed by welding the first end portion and the second end portion.

10. The secondary battery according to claim 1, wherein
the case main body includes a pair of first wall portions facing each other in a second direction orthogonal to the first direction,
the bent portion is provided in at least one of the first wall portions,
the joining portion includes a first region and a second region located opposite to the first region with respect to the bent portion,
each of the first region and the second region extends in the first direction,
the at least one of the first wall portions has a first center line extending in the first direction through a center of the first wall portion in a third direction orthogonal to the first direction and the second direction,
the first region is located close to the first center line of the first wall portion with respect to the second region,
the case main body is constituted of a plate-shaped member including a first end portion and a second end portion, and
the joining portion is formed by welding the first end portion and the second end portion.

11. The secondary battery according to claim 1, wherein
the case main body includes a pair of first wall portions facing each other in a second direction orthogonal to the first direction,
the bent portion is provided in at least one of the first wall portions,
the at least one of the first wall portions has a second center line extending in a third direction orthogonal to the first direction and the second direction through a center of the first wall portion in the first direction,
the joining portion is formed substantially symmetrically with respect to the second center line,
the case main body is constituted of a plate-shaped member including a first end portion and a second end portion, and
the joining portion is formed by welding the first end portion and the second end portion.

12. The secondary battery according to claim 1, wherein
the case main body includes a pair of first wall portions facing each other in a second direction orthogonal to the first direction,
the bent portion is provided in at least one of the first wall portions,
the case main body includes a pair of second wall portions orthogonal to each other in a third direction orthogonal to the first direction and the second direction,
an area of each of the first wall portions is smaller than an area of each of the second wall portions,
the case main body is constituted of a plate-shaped member including a first end portion and a second end portion, and
the joining portion is formed by welding the first end portion and the second end portion.

13. The secondary battery according to claim 1, wherein the case has a substantially rectangular parallelepiped shape.

14. The secondary battery according to claim 1, wherein
the case main body includes a pair of first wall portions facing each other in a second direction orthogonal to the first direction,
the bent portion is provided in at least one of the first wall portions, and
the case has a substantially rectangular parallelepiped shape.
